(19) United States
(12) Patent Application Publication
(10) Pub. No.: US 2017/0021556 A1
(43) Pub. Date: Jan. 26, 2017

(54) METHOD FOR MANUFACTURING A FITTING COMPONENT FOR PERSONAL FALL PROTECTION EQUIPMENT

(71) Applicant: Skylotec GMBH, Neuwied (DE)

(72) Inventor: Kai Rinklake, Neuwied (DE)

(73) Assignee: Skylotec GMBH, Neuwied (DE)

(21) Appl. No.: 15/216,791

(22) Filed: Jul. 22, 2016

(30) Foreign Application Priority Data
Jul. 22, 2015 (DE) 10 2015 009 295.2

(51) Int. Cl. B29C 63/24; B29C 39/02; A62B 35/00; B29C 65/48; B29C 65/56; B29C 65/00; B29C 39/10; B29C 45/14

(52) U.S. Cl. CPC B29C 63/24; B29C 39/10; B29C 39/02; B29C 45/14819; B29C 65/48; B29C 65/56; B29C 66/69; A62B 35/0037; B29K 2105/20

(57) ABSTRACT

The invention relates to a method for manufacturing a fitting component for personal fall protection equipment including the steps of winding a fiber to form a plurality of windings, and covering the fiber with a plastic, in such a manner that the fitting component is obtained and, corresponding to the core of the windings, an opening in the fitting component is obtained.

### CROSS-REFERENCE TO RELATED APPLICATION

This application claims the benefit of German Patent Application DE 10 2015 009 295.2 filed Jul. 22, 2015 which is herein incorporated by reference in its entirety.

### BACKGROUND

The invention relates to a method for manufacturing a fitting component for personal fall protection equipment, comprising the step: winding a fiber to form a plurality of windings.

Personal fall protection equipment, also called personal fall arrest system or, abbreviated, PFAS, is generally understood to be equipment that persons covered by employer liability insurance use when there is a risk of falling, if technical or organizational fall protection is not possible. Furthermore, personal fall protection equipment is also used in the recreational sector, to protect a person using the fall protection equipment from falling. For example, climbing harnesses are included in fall protection equipment and have multiple fitting components, such as, in many cases, buckles, O-rings and D-rings, connection elements, attachment points or the like.

In the sector of personal fall protection equipment, such fitting components are generally composed of a metal, with sufficient dimensioning to be able to absorb the forces that occur in the event of a fall. Because a plurality of fitting components is generally provided on a climbing harness, it is not rare that the weight of all the fitting components adds up to several kilograms, thereby making use of the climbing harness uncomfortable. Previous attempts to manufacture fitting components from non-metallic materials have failed due to the lack of stability of the non-metallic materials used, for one thing, and due to the extraordinarily high costs for processing of the non-metallic materials.

### SUMMARY

Proceeding from this situation, it is an object of the invention to indicate a method for manufacturing a fitting component for personal fall protection equipment, so that a fitting component having sufficient strength to protect a person from falling can be manufactured in nonetheless cost-efficient manner.

The solution for the object is achieved by means of the characteristics of the independent claim. Advantageous embodiments are indicated in the dependent claims.

Accordingly, the object is accomplished by a method for manufacturing a fitting component for personal fall protection equipment, comprising the steps: winding a fiber to form a plurality of windings and covering the fiber with a plastic in such a manner that the fitting component and, corresponding to the core of the windings, an opening in the fitting component is obtained.

A significant aspect of the invention is that the forces that occur during a fall of a person protected by the fitting component are absorbed by the fiber wound to form multiple windings, while external protection of the fiber against mechanical wear during regular use, for example, or against UV rays, is provided by the plastic. The fitting component obtained by means of the proposed method is characterized, as compared with a fitting component made of metal, by significantly lower weight at the same stability and strength. Corrosion that regularly occurs in the case of fitting components composed of metal does not take place, because of the use of synthetic fibers and plastic, for example, while fundamentally, new areas of application are opened up, for example in areas at risk of explosion. Furthermore, the method is characterized by a high degree of automation, corresponding process reliability, and related cost-efficiency.

As compared with other methods known from the state of the art, such as, for example, what is called tape laying, the proposed method is characterized, among other things, in that the fiber and the plastic are not “baked” in an oven, for example. In this regard, no material connection between fiber and plastic takes place, and this significantly simplifies the production of the fitting component. Furthermore, it is possible, in the case of the proposed method, as compared with tape laying, to achieve sufficient stability and strength solely by means of the windings, on the one hand, and, on the other hand, to create an optically freely shaped and thereby appealing external shape of the fitting component in fundamentally one process step, by means of covering the fiber or the windings. In contrast, tape laying is significantly more complicated and is regularly characterized by further processing steps, for example by a subsequent processing step such as cutting for subsequent treatment of the external shape.

The multiple windings are disposed parallel and/or next to one another, preferably touching one another and/or comparable to a coil, by means of winding the fiber up to form the plurality of windings. The fiber preferably extends continuously between its ends and thereby specifically does not consist of individual fiber pieces strung together. The windings, i.e. the fiber is/are preferably covered completely by the plastic, and an external shape of a hoop or tube, for example, is formed. The opening and/or the cross-sectional surface or the profile of the fitting component in its longitudinal expanse is preferably configured to be circular, similar to a circle, rectangular, an oblong hole, a slit, a longitudinal slit or the like, in such a manner that a belt or a strap of a climbing harness, for example, as personal fall protection equipment, can be passed through the opening. Preferably, the fitting component is closed along its circumference direction and/or designed for personal fall protection equipment.

According to a preferred further embodiment, the method has the step: fixing the windings in place, after winding and before covering, using a resin and/or an adhesive, and/or saturating the fiber, before or after winding, with a resin and/or an adhesive. The resin preferably comprises a synthetic resin, for example polyester resin or epoxy resin, with the use of a natural resin also being possible. By means of fixing the windings in place, preferably with resin and/or adhesive, the fiber laid into windings remains in the wound-up form, so that in advantageous manner, the individual windings cannot slip relative to one another when they are subsequently covered with plastic and/or maintain their respective position in an injection-molding die, for example, used to cover them with plastic. It is furthermore advantageous that introduction of the windings into the injection-molding die can be automated by means of fixing in place or saturation, so that the windings form a fixed unit in and of themselves.

Fundamentally, winding the fiber can take place in any desired manner. According to a particularly advantageous further embodiment, the method has the further steps: before winding, providing a support structure composed of a plastic, winding the fiber around the support structure or applying the windings to the support structure, and covering the support structure around which the fiber is wound with the plastic, so that the fitting component is obtained. Fundamentally, different possibilities exist for embodying the support structure, with an embodiment in the manner of a rim having a circle-type, rectangle-type or oblong-hole-type opening being preferred. When applying the windings to the support structure, the latter is configured in the manner of half shells, for example, into which the windings can be laid and are fixed in place within the half shells when the half shells are connected with one another. By using the support structure, the fiber can be wound onto, rolled onto and/or coiled onto the support structure in particularly simple manner, forming the windings that lie on the support structure, preferably touching at least in part, thereby making improved handling and storage of the fiber wound on in this manner possible. Furthermore, the support structure allows precise positioning of the fiber when it is subsequently covered with plastic, for example in an injection-molding die, without cost-intensive ejectors or positioning aids being required.

Fundamentally, different possibilities exist for covering the fiber and/or for making the support structure available. According to a preferred further embodiment, making the structure available and/or covering the fiber comprise(s) injection and/or casting, preferably injection molding. Injection molding preferably takes place in an injection-molding machine. The plastic is liquefied by being heated, and injected, under pressure, into a mold, the injection-molding die, into which the fiber wound up to form windings has previously been introduced. In the die, the plastic that covers the fiber is transformed to the solid state by cooling. After the die is opened, the finished fitting component can be removed from the injection-molding machine. The plastic of the support structure and the plastic used for covering the support structure can be identical or different; fundamentally, the use of a single injection-molding machine with different molds, one for the support structure and one for the external shaping of the fitting component by injecting plastic around the support structure and the fiber, is possible. Preferably, the fiber is completely covered and/or the support structure is covered at least in part, preferably completely, by the plastic.

In a further advantageous embodiment, an injection-molding die is used for covering the windings, configured in such a manner that an O-ring, a D-ring, a buckle, a connection element or an attachment point is obtained as a fitting component. In this way, the external shape or surface of the fitting component can be determined by the injection-molding die. The buckle can have a center crosspiece or crosspiece, as will be explained in detail below.

Configuring the support structure can fundamentally take place in different ways. In a particularly preferred further embodiment, the support structure has a guide, preferably a circumferential guide, a support surface for the fiber and/or a circle-like or rectangle-like shape, around which or into which the fiber can be wound or applied. Preferably, the windings or coils analogously have a circle-like or rectangle-like cross-section. The cross-section of the windings preferably corresponds to the cross-section of the guide or of the support surface. In addition, further embodiments of the support structure are also conceivable, for example a support surface for the fiber in the manner of an oblong hole or an oval in cross-section, with a corresponding cross-section of the windings being achieved. Preferably, a plurality of guides spaced apart from one another, disposed circumferentially on an edge of the support structure and/or extending radially away from the support structure are provided.

In a preferred further embodiment, the fiber is formed at least in part, preferably entirely, by a natural fiber, chemical fiber and/or an inorganic fiber, preferably as a basalt fiber, boron fiber, glass fiber, ceramic fiber, silica fiber, steel fiber, aramid fiber, carbon fiber, polyester fiber, nylon fiber, polyethylene fiber, Plexiglas fiber, wood fiber, flax fiber, hemp fiber, metal fiber and/or sisal fiber; it is formed at least in part, preferably entirely, as a woven fabric, interlaid scrim, multi-axial interlaid scrim, embroidered fabric, braid, nonwoven fabric, a mat and/or a fine cut and/or is formed at least in part, preferably entirely, by a long fiber and/or an endless fiber. In many cases, fibers comprising a length between their ends of 1 to 50 mm are designated as long fibers, while endless fibers often have a length of more than 50 mm. A fitting component having great rigidity and strength can be manufactured in particularly advantageous manner by using an endless fiber.

It has proven to be particularly advantageous for the embodiment of the plastic, according to a further embodiment, if it comprises a thermoplastic, a duroplastic and/or an elastomer, acrylonitrile/butadiene/styrene, ABS, polyamide PA, preferably in the embodiment PA6, polylactate, PLA, polymethylmethacrylate, PMMA, polycarbonate, PC, polyethylene terephthalate, PET, polyethylene, PE, polypropylene, PP, polystyrene, PS, polyetheretherketone, PEEK, and/or polyvinyl chloride, PVC. A person skilled in the art will set the operating parameters required for injection molding in accordance with the plastic selected.

In yet another preferred further embodiment, a surface of the fitting component is configured in such a manner, by means of covering it with plastic, that the support structure lies against the surface, at least in part, preferably touching it, and/or the plastic of the support structure and the plastic that covers the support structure around which the fiber is wound have different colors. Different colors are present, for example, if the colors represent different points of a three-dimensional color space, have different RGB values, are different according to the Pantone color catalog, etc. Design possibilities and marking possibilities of the fitting component can be formed and/or varied in advantageous manner by using plastics having different colors. For example, the support structure can be injection-molded using orange-colored plastic, and the plastic that covers the support structure and the fiber can be colored black. In this case, the support structure preferably lies against the injection-molding die with its guide touching, so that the finished fitting component has a different color on the guide that reaches all the way to its surface than in the regions that lie adjacent, in which the support surface does not reach all the way to the surface.

Fundamentally, any desired number of windings can be provided. However, it has proven to be advantageous if the fiber is wound with ≧30, ≧40, ≧50 or ≧60 windings. ≧50 and ≦60 [sic] windings are particularly advantageous, in order to achieve sufficient rigidity with a simultaneously cost-advantageous production method. With the number of windings last mentioned, it was possible to document experimentally that the fitting component does not demonstrate any lasting deformation under a [metric] ton of stress.

For manufacturing a fitting component having a center crosspiece, the method, in a preferred further embodiment, has the following steps: winding a second fiber to form a plurality of second windings, winding a third fiber to form a plurality of third windings around the windings and around the second windings, so that the windings and the second windings lie against one another in a region that forms the center crosspiece, in each instance, and lie against the third windings in a region different from the center crosspiece, in each instance, and covering the fiber and the second fiber with a plastic, so that the fitting component is obtained with the center crosspiece and a second opening corresponding to the core of the second windings.

In a preferred further embodiment, the method has the steps: before winding, providing a second support structure composed of the plastic, winding the second fiber around the second support structure or applying the second windings to the second support structure, before winding the third fiber, joining together the support structure and the second support structure, and covering the support structure around which the fiber is wound and the second support structure around which the second fiber is wound with the plastic. In an even further preferred embodiment, joining together takes place by means of clipping the support structure and the second support structure together, locking them into one another and/or gluing them to one another.

By means of winding the third windings around the windings and the second windings, a buckle having the center crosspiece, for example, can be formed, which has a strength and rigidity comparable to that of a buckle composed of metal. For manufacturing a buckle, the opening, the windings and/or the support structure are preferably structured as a D-ring, an oblong hole, or as a slit, and the second opening, the second windings and/or the second support structure are structured as an oblong hole or as a slit. The center crosspiece is configured between the opening and the second opening in this manner. Further embodiments and advantages of the second fiber, the third fiber, the second windings, the third windings and/or the second support structure are evident to a person skilled in the art by analogy to what has been described above.

According to another further embodiment, it is preferred that the method has the step of winding the fiber to form the plurality of windings as a figure eight, and/or winding the fiber to form the plurality of windings as a figure eight and around the figure eight, so that the winding wound around the figure eight lies against the figure eight at least in part. On the one hand, the fiber, in the simplest case, can be wound in two windings as a figure eight, with each winding forming one of the two circle-type parts of the figure eight. On the other hand, one winding can be wound first and the figure eight can be configured by rotating part of the winding by 180° around the longitudinal axis. Preferably, the windings are alternately wound as a figure eight and around the figure eight. Likewise, a plurality of windings can be wound as a figure eight and thereupon a plurality of windings can be wound around the figure eight.

According to yet a further preferred embodiment, the fiber is configured as an endless fiber. The endless fiber preferably has an endless woven structure and/or is structured as an endless cable.

The object of the invention is furthermore accomplished by a method for manufacturing a fitting component, preferably closed in the circumference direction, preferably structured for personal fall protection equipment, comprising the steps: making a support structure composed of a plastic available, winding a fiber around the support structure in multiple windings, preferably in a cross-section corresponding in the circumference direction, and covering the support structure around which the fiber is wound with a plastic, so that the fitting component is preferably obtained with an opening that corresponds to the core of the windings.

### BRIEF DESCRIPTION OF THE DRAWINGS

In the following, the invention will be explained in greater detail, making reference to the attached drawings, using a preferred embodiment.

The figures show:

FIGS. 1 and 2 a sequence for manufacturing a fitting component according to a preferred exemplary embodiment of the invention,

FIG. 3 a support structure according to a preferred exemplary embodiment of the invention,

FIG. 4 the support structure according to FIG. 3 with a fiber wound on,

FIGS. 5 and 6 a sequence for manufacturing a fitting component comprising a center crosspiece, according to a preferred exemplary embodiment of the invention,

FIG. 7 a fitting component according to the preferred exemplary embodiment of the invention, obtained by means of the sequence shown in FIGS. 5 and 6, and

FIG. 8 a winding according to a further exemplary embodiment of the invention.

### DESCRIPTION OF THE SELECTED EMBODIMENTS

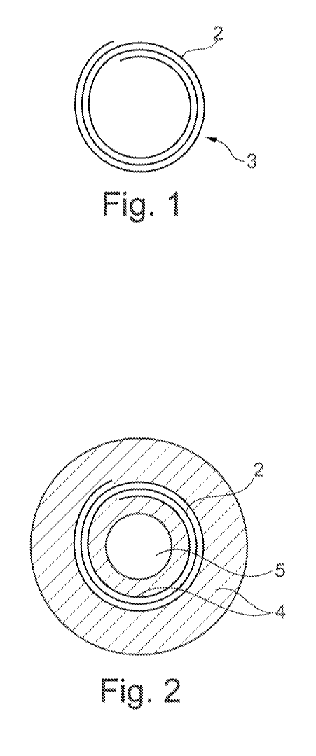

FIGS. 1 and 2 show a step sequence for manufacturing an O-ring as a fitting component 1 for personal fall protection equipment, according to a preferred exemplary embodiment of the invention.

In a first step, a fiber 2 is wound up to form a plurality of circular windings 3. Winding can take place manually, for example, around a “virtual” core. In advantageous manner, a winding machine, a coil winding machine or the like is used, by means of which the fiber 2 is wound around a correspondingly circular-shaped core to form the plurality of windings 3. After winding, the core is pulled off, so that the fiber 2 remains in the wound-up state. In FIG. 1, three windings 3 are shown as examples; experimentally, 50 to 60 windings 3 have proven to be particularly advantageous.

The fiber 2 consists of aramid and is thereby characterized by great rigidity values and strength values. The fiber 2, which has been wound up to form windings 3, can absorb the forces that occur during a fall of a person protected with the fitting component 1 manufactured according to the proposed method, without tearing. Alternatively, it is also possible to use a natural fiber, other chemical fibers, an inorganic fiber or a combination of the aforementioned fibers 2. In the present case, the fiber 2 is configured as a long fiber, so that only a single, continuous fiber 2 is used for the 50 to 60 windings. After the 50 to 60 windings 3 have been wound up, the fiber 2 is cut off using a severing means known to a person skilled in the art, for example scissors.

In a second step, the fiber 2 or the plurality of windings 3 is completely covered with a plastic 4, so that the O-ring is obtained as a fitting component 1 in a hoop-like shape. A circular opening 5 is formed in the fitting component, corresponding to the core of the windings 3. A harness strap, not shown, can be passed through the opening 5, for example, by means of which strap the fitting component 1 can be attached to a climbing harness as personal fall protection equipment. Covering the fiber 2 or the plurality of windings 3 takes place by means of a plastic injection-molding method, using an injection-molding machine.

The injection-molding machine liquefies the plastic 4 by heating it and injects the liquefied plastic 4 into an injection-molding die. The wound-up fiber 2 or the plurality of windings 3 has previously been laid into the injection-molding die. The injection-molding die has a negative shape of the designated O-ring and thereby forms the external shape of the fitting component 1 by means of injection molding. After the plastic 4 has cooled off, the O-ring formed by the fiber 2 or the windings 3 and the plastic 4 can be removed from the injection-molding machine as a fitting component 1. While the fiber 2 absorbs the forces that occur during a fall, as explained above, the plastic 4 serves as protection for the fiber 2 against mechanical stresses and damage in everyday use, and as protection against UV radiation.

Fundamentally, a duroplastic or an elastomer can be used as the plastic 4, with a thermoplastic being used in the present case, preferably polyamide PA in the embodiment polycaprolactam PA6. In addition, it is also possible to use acrylonitrile/butadiene/styrene, ABS, polylactate, PLA, polymethylmethacrylate, PMMA, polycarbonate, PC, polyethylene terephthalate, PET, polyethylene, PE, polypropylene, PP, polystyrene, PS, polyetheretherketone, PEEK, and/or polyvinyl chloride, PVC.

In an optional step, the fiber 2 is already saturated with a resin, for example a synthetic resin such as epoxy resin or polyester resin, a duroplastic or a thermoplastic, or an adhesive, so that the individual windings 3 connect with one another by being wound up, and form a structure of the windings 3 that is fixed in place or stable in shape. Even better fixation of the fiber 2 wound up to form the windings 3 can be achieved by heating the fiber 2 saturated in this manner, for example by “baking” the windings 3 in an oven.

Alternatively, the windings 3 of the fiber 2 can also be saturated after being wound up, in order to thereby achieve fixation of the fiber 2 wound up to form the windings 3. As a result, the windings 3 do not slip relative to one another during subsequent covering of the fiber 2 with the plastic, and remain in their fixed position during injection molding, for example. Both winding and covering the fiber 2 can be automated in suitable manner, for example using a winding machine that has already been mentioned, and a robot for laying the wound fiber 2 into the injection-molding machine and removing the windings 3 that have plastic 4 injection-molded around them from the injection-molding machine, as a finished fitting component 1.

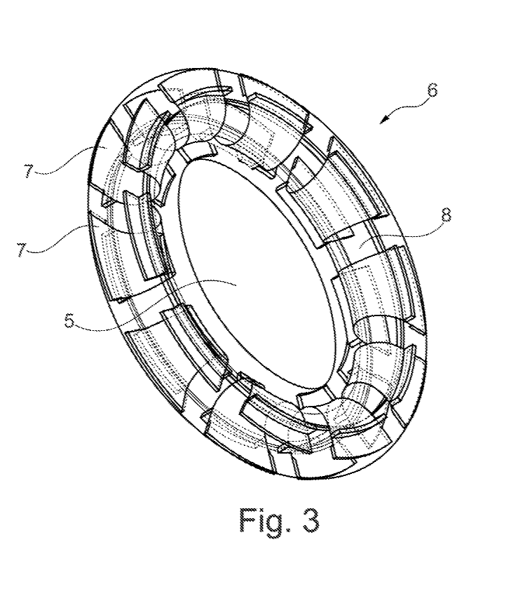

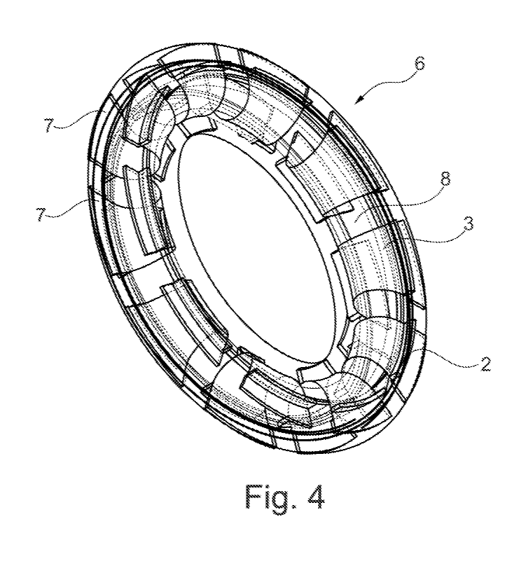

FIG. 3 shows a further exemplary embodiment, building on the exemplary embodiment shown in FIGS. 1 and 2 and described above, in which a support structure 6 composed of a plastic 4 is made available before winding. The support structure 6 has a rim-like shape with a circumferential guide 7, as well as a circular, circumferential support surface 8. The guide 7 is formed by periodically disposed guide surfaces that extend away radially on both sides of the support surface. The fiber 2 is wound up onto the support structure 6 around the support surface 8, as shown in FIG. 4. In this way, the direction of rotation of the windings 3 runs corresponding to the edge of the support structure 6, or the cross-section of the windings 3 corresponds to the cross-section of the support structure 6.

Lateral guidance on both sides is achieved for the fiber 2 or windings 3 that lie(s) on the support surface 8, touching it, by means of the guide 7. In a further embodiment, not shown, the fiber 2 that has been wound up to form the windings 3 can be applied to the support structure 6, for example by laying it on. In this case, the support structure 6 can be structured by two hoop-like half shells, which can be connected with one another, for example by clipping or locking them, so that in this way, the windings 3 are accommodated between the half shells and fixed in place on the support structure 6 in the accommodated position.

As in the previous exemplary embodiment, the external shape of the fitting component 1 is obtained by completely covering the support structure 6, around which the fiber 2 has been wound, with the plastic 4. The injection-molding die used for this purpose is configured in such a manner that the support structure 6 comes to lie on a surface of the fitting component 1, at least in part, and thereby is visible at the surface. The color design of the fitting component 1 can be varied by using different colors for the plastic 4 of the support structure 6 and for the plastic 4 used for covering the support structure 6 as well as the fiber 2, and/or an identification function can be created. In the present case, the same plastic 4 as for the support structure 6 is used for covering the support structure 6 provided with the fiber 2. Alternatively, a different type of plastic 4 can also be used for covering the fiber 2, for example a further or second plastic.

Aside from an O-ring as a fitting component 1, other fitting components 1, such as, for example, a D-ring, a buckle, a connection element or an attachment point can also be manufactured using the proposed method. In accordance with the desired shape, in each instance, for example in the case of a D-ring, a person skilled in the art will wind up the fiber 2 to form windings 3 in a shape corresponding to the external shape of the D-ring, will provide a support structure 6 in its external shape and/or in the form of its support surface 8 corresponding to the external shape of the D-ring, and/or an injection-molding die or an injection-molding mold corresponding to the external shape of the D-ring. In an optional embodiment, the support structure 6 can also be manufactured by injection molding, for example by a preceding method step.

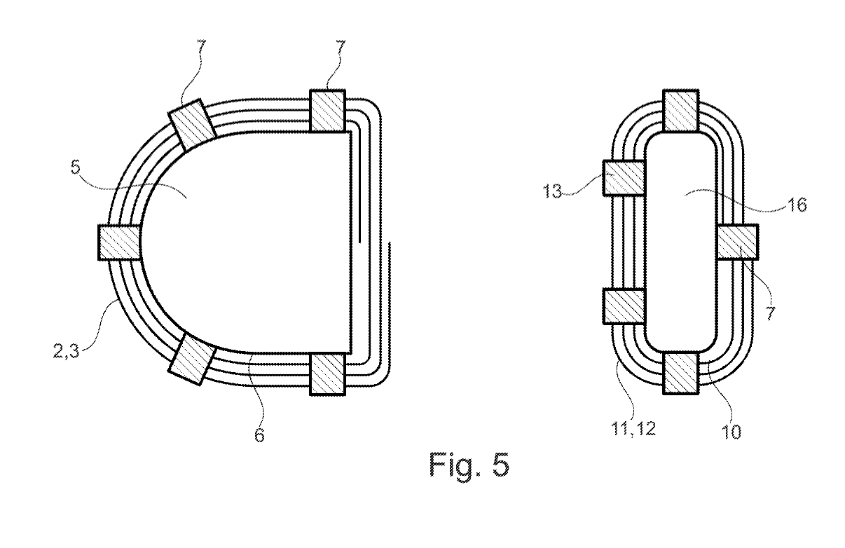

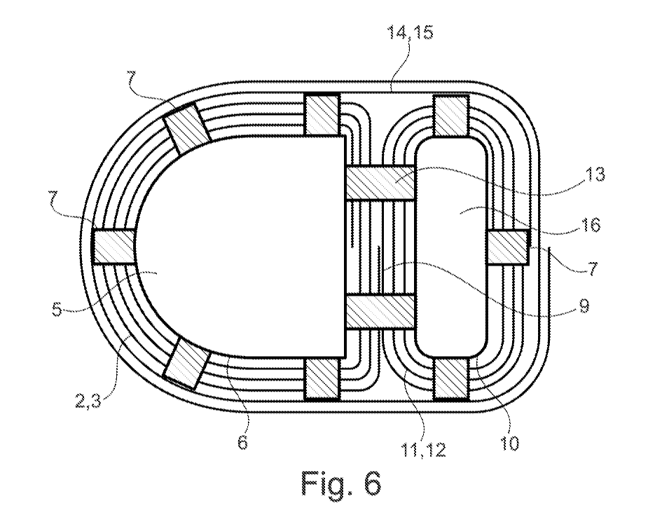

FIGS. 5 and 6 show a step sequence for manufacturing a buckle as a fitting component 1 according to a further exemplary embodiment of the invention. The support structure 6 shown on the left in FIG. 5, with a continuous fiber 2 wound onto it, to form windings 3, corresponds to the exemplary embodiment shown in FIG. 4. A further support structure 10 is shown on the right in FIG. 6; in a top view, it has a rectangle-like cross-sectional shape with rounded-off corners.

A second fiber 11 with 50 to 60 second windings 12 is wound around the second support structure 10. The second windings 12 also have a rectangle-like cross-section with rounded-off edges, corresponding to the second support structure 10. For lateral guidance of the second windings 12, the second support structure 10 also has multiple guides 7 at a distance from one another.

The support structure 6 and/or the second support structure 10 has/have a connection device 13, by means of which the support structure 6 and the second support structure 10 can be locked into one another to form a common unit, in such a manner that the windings 3 and the second windings 12 lie against one another, at least in part, in a region that forms the center crosspiece 9. A third fiber 14 is wound around the windings 3 and the second windings 12 in a plurality of third windings 15, so that the windings 3 and the second windings 12 lie against the third windings 14 [sic—should be 15], touching, in a region that is different from the center crosspiece 9.

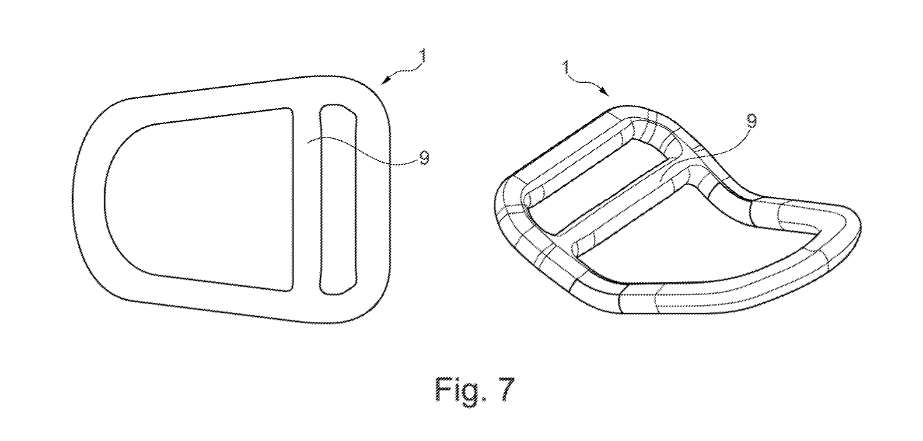

After covering the fiber 2 and the second fiber 11 by injection-molding with the plastic 4, the fitting component 1 shown on the left in FIG. 7, comprising the center crosspiece 9, is obtained. The second fiber 12 and the third fiber 14 are composed of the same material as the fiber 2, in each instance, and extend continuously along their 50 to 60 second and third windings 12, 15, respectively, between their respective ends.

The fitting component 1 shown in FIG. 1, comprising a center crosspiece 9, can be manufactured, on the one hand, as described above, with a support structure 6 and a second support structure 10, but as described with reference to FIGS. 1 and 2, production without a support structure 6 and a second support structure 10 is also possible. In a further embodiment, the support structure 6 and the second support structure 10 can have a soft or deformable material, which is bent and/or laid into a die either before or after winding of the fiber 2, the second fiber 11 and/or the third fiber 14, so that the fitting component 1, as shown in FIG. 7, forms a curved longitudinal expanse. According to a further embodiment, not shown, it is possible that the opening 5 and the second opening 16 are structured as longitudinal slits, in each instance, in order to obtain a buckle comprising two longitudinal slits as a fitting component 1.

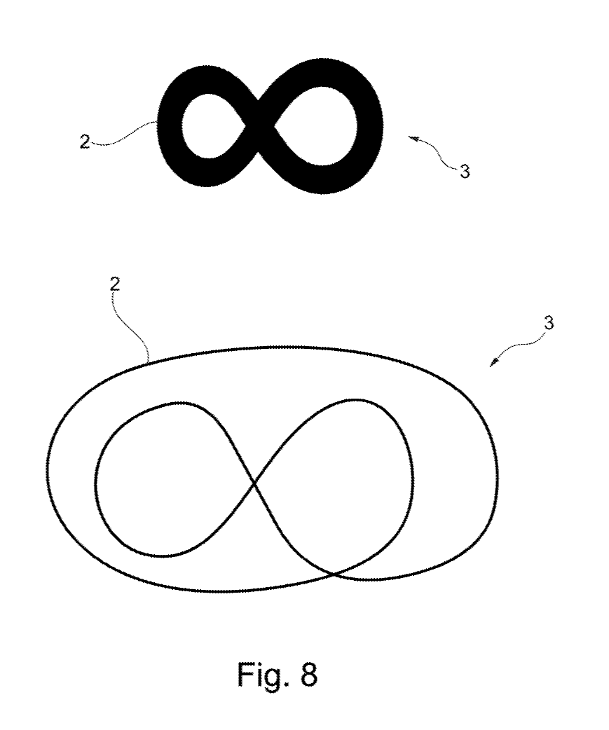

FIG. 8, top, shows a further embodiment of the invention, in which the fiber 2 is wound as a figure eight in two windings 3. FIG. 8, bottom, shows the fiber 2, at first in two windings 3 as a figure eight and then in a winding 3 wound around the figure eight. The winding 3 that is wound around the figure eight lies against the figure eight at least in part, and is configured as an endless fiber 2.

### REFERENCE SYMBOL LIST

Fitting component 1
Fiber 2
Windings 3
Plastic 4
Opening 5
Support structure 6
Guide 7
Support surface 8
Center crosspiece 9
Second support structure 10
Second fiber 11
Second windings 12
Connection means 13
Third fiber 14
Third windings 15
Second opening 16

I claim:

1. A method for manufacturing a fitting component for personal fall protection equipment, comprising the steps:
winding a fiber to form a plurality of windings, and
covering the fiber with a plastic in such a manner that the fitting component and, corresponding to the core of the windings, an opening in the fitting component is obtained.

2. The method according to claim 1, comprising the step:
fixing the windings in place, after winding and before covering, using a resin and/or an adhesive, and/or
saturating the fiber, before or after winding, with a resin and/or an adhesive.

3. The method according to claim 1, comprising the steps:
before winding, providing a support structure composed of a plastic,
winding the fiber around the support structure or applying the windings to the support structure, and
covering the support structure around which the fiber is wound with the plastic, so that the fitting component is obtained.

4. The method according to claim 3, wherein providing the structure and/or covering the fiber comprises injection molding and/or casting.

5. The method according to claim 1, wherein an injection-molding die is used for covering the windings, configured in such a manner that a ring, a buckle, a connection element or an attachment point is obtained as a fitting component.

6. The method according to claim 1, wherein the support structure has a circumferential guide, and/or a support surface for the fiber, and/or the support structure has a circle-like or rectangle-like shape, around which or into which the fiber can be wound or applied.

7. The method according to claim 1, wherein the fiber is formed, at least in part or entirely, by a natural fiber, chemical fiber and/or an inorganic fiber comprising: a basalt fiber, boron fiber, glass fiber, ceramic fiber, silica fiber, steel fiber, aramid fiber, carbon fiber, polyester fiber, nylon fiber, polyethylene fiber, Plexiglas fiber, wood fiber, flax fiber, hemp fiber, metal fiber and/or sisal fiber; it is formed at least in part or entirely, as a woven fabric, interlaid scrim, multi-axial interlaid scrim, embroidered fabric, braid, nonwoven fabric, a mat and/or a fine cut and/or is formed at least in part or entirely, by a long fiber and/or an endless fiber.

8. The method according to claim 1, wherein the plastic comprises a thermoplastic, a duroplastic and/or an elastomer, acrylonitrile/butadiene/styrene, ABS, polyamide PA, PA6, polylactate, PLA, polymethylmethacrylate, PMMA, polycarbonate, PC, polyethylene terephthalate, PET, polyethylene, PE, polypropylene, PP, polystyrene, PS, polyetheretherketone, PEEK, and/or polyvinyl chloride, PVC.

9. The method according to claim 3, wherein a surface of the fitting component is configured in such a manner, by means of covering it with plastic, that the support structure lies against the surface, at least in part, and/or the plastic of the support structure and the plastic that covers the support structure around which the fiber is wound have different colors.

10. The method according to claim 1, wherein the fiber is wound with ≧30, ≧40, ≧50 or ≧60 windings.

11. The method according to claim 1, comprising the steps:
winding a second fiber to form a plurality of second windings,
winding a third fiber to form a plurality of third windings around the windings and around the second windings, so that the windings and the second windings lie against one another in a region that forms a center crosspiece, in each instance, and lie against the third windings in a region different from the center crosspiece, in each instance, and
covering the fiber and the second fiber with a plastic, so that the fitting component is obtained with the center crosspiece and a second opening corresponding to the core of the second windings.

12. The method according to claim 3, comprising the steps:
before winding, providing a second support structure composed of the plastic,
winding the second fiber around the second support structure or applying the second windings to the second support structure,
before winding the third fiber, joining together the support structure and the second support structure, and
covering the support structure around which the fiber is wound and the second support structure around which the second fiber is wound with the plastic.

13. The method according to the claim 12, wherein joining together takes place by means of clipping the support structure and the second support structure together, locking them into one another and/or gluing them to one another.

14. The method according to claim 1, comprising the step:
winding the fiber to form the plurality of windings as a figure eight, and/or
winding the fiber to form the plurality of windings as a figure eight and around the figure eight, so that the winding wound around the figure eight lies against the figure eight at least in part.

15. The method according to claim 14, wherein the fiber is configured as an endless fiber.

16. The method according to claim 1, wherein providing the structure and/or covering the fiber comprises injection molding and/or casting.

17. A method for manufacturing a fitting component for personal fall protection equipment, comprising the steps:
providing a support structure composed of a first plastic,
winding a fiber to form a plurality of windings around the support structure, and
covering the fiber and the support structure being winded around with the fiber with a second plastic in such a manner that the fitting component comprising the fiber and the support structure and, corresponding to the core of the windings, an opening in the fitting component is obtained.

18. The method according to claim 17, comprising the steps:
winding a second fiber to form a plurality of second windings,
winding a third fiber to form a plurality of third windings around the windings and around the second windings, so that the windings and the second windings lie against one another in a region that forms a center crosspiece, in each instance, and lie against the third windings in a region different from the center crosspiece, in each instance, and covering the fiber and the second fiber with a plastic, so that the fitting component is obtained with the center crosspiece and a second opening corresponding to the core of the second windings.

19. The method according to claim 17, comprising the step:
winding the fiber to form the plurality of windings as a figure eight, and/or winding the fiber to form the plurality of windings as a figure eight and around the figure eight, so that the windings wound around the figure eight lie against the figure eight at least in part.

20. The method according to claim 19, wherein the fiber is configured as an endless fiber.
